(19) United States
(12) Patent Application Publication
(10) Pub. No.: US 2016/0245468 A1
(43) Pub. Date: Aug. 25, 2016

(54) DECK LIGHT WITH INTERCHANGEABLE HOUSINGS

(71) Applicant: Volt, LLC, Tampa, FL (US)

(72) Inventor: Michael Grant Breedlove, SR., Odessa, FL (US)

(21) Appl. No.: 14/627,840

(22) Filed: Feb. 20, 2015

(51) Int. Cl. F21S 8/00; F21V 5/04; F21V 15/01

(52) U.S. Cl. CPC F21S 8/036; F21V 15/01; F21V 5/048; F21Y 2101/02

(57) ABSTRACT

A deck light has interchangeable front housings. The deck light comprising a back plate having a light source, the back plate configured for attachment to a fixed support structure. A front housing configured for removable coupling to the back plate is also provided. The front housing directs escape of light from the light source in a predetermined direction. One of the back plate and the front housing has a circular opening and another of the back plate and the front housing has a circular flange receivable in the circular opening. An interconnect arrangement is carried by the circular opening and the circular flange, the interconnect arrangement being configured to removably couple the front housing to the back plate.

### FIELD OF THE INVENTION

The present invention relates generally to the art of low voltage deck lighting.

### BACKGROUND

Various styles of light fixtures have been provided over the years to illuminate outdoor decks, stairways, and the like. For example, such light fixtures are often mounted to a deck structure (e.g., a support post or railing) as a downwardly-directed sconce. By illuminating an area of the surface of the deck, these lights provide pleasing aesthetics and also assist a person who is walking on the deck at night. Deck lights come in a variety of styles and shapes.

Common deck lighting systems have three primary components: a power source, electrical wiring, and the individual lighting fixtures. The power source may be a multi-tap transformer that is mounted in a box in the garage or utility closet, plugs into a standard 120 VAC outlet, and provides outputs at multiple voltages. For example, a common multi-tap transformer has AC outputs at 12V, 13V, 14V, and 15V, where the higher voltages are often used to overcome voltage loss from high wattage loads or long cable runs. The transformer box may also have control circuitry and be used as a control panel for collectively controlling the multiple lighting fixtures. For example, the box can include a timer that turns all of the lights on or off at specified intervals.

Deck light fixtures typically include integral wiring that extends from the housing a sufficient length for connection to a trunk line extending from the transformer. If a homeowner decided to change the light fixture (such as to achive a new “look”), this would involve the arduous task of not only removing the light fixture from the deck structure, but also removing the associated wiring for that fixture. The replacement fixture is then installed.

### SUMMARY

One aspect of the present invention provides a deck light comprising a back plate having a light source, the back plate configured for attachment to a fixed support structure. A front housing configured for removable coupling to the back plate is also provided. The front housing directs escape of light from the light source in a predetermined direction. One of the back plate and the front housing has a circular opening and another of the back plate and the front housing has a circular flange receivable in the circular opening. An interconnect arrangement is carried by the circular opening and the circular flange, the interconnect arrangement being configured to removably couple the front housing to the back plate.

In accordance with a preferred embodiment, the circular opening is defined in the front housing and the back plate includes the circular flange. For example, the interconnect arrangement may comprise at least one radial protrusion on the circular flange and a corresponding slot defined in the circular opening through which the protrusion passes during coupling of the front housing to the back plate.

Embodiments are contemplated in which the front housing includes a main cowling to which an adapter plate is attached, the circular opening being defined in the adapter plate. For example, the adapter plate may be generally configured to match the peripheral dimensions of the main cowling. Preferably, the front housing further comprises a lens.

According to another aspect, the present invention provides a deck light comprising a back plate configured for attachment to a fixed support structure, the back plate carrying at least one LED. Electrical wiring extends to the back plate for connection to an external power source. A front housing configured for removable coupling to the back plate is also provided, the front housing directing escape of light from the light source in a predetermined direction. The front housing includes a main cowling to which an adapter plate is attached, a circular opening being defined in the adapter plate. The back plate has a circular flange receivable in the circular opening. An interconnect arrangement is carried by the circular opening and the circular flange, and is configured to removably couple the front housing to the back plate.

According to another aspect, the present invention provides a method of interchanging a first front housing portion of a deck light with a second front housing portion. One step of the method involves providing a deck light having a back plate attached to a fixed support structure, the back plate carrying at least one LED as a light source. The back plate has a circular flange with at least one interconnect feature configured to removably couple with a corresponding interconnect feature of the first front housing and the second front housing. Another step of the method involves removing the first front housing at least in part by rotation of the first front housing with respect to the back plate in a first rotational direction. According to another step, the second front housing is then coupled at least in part by rotation of the second front housing with respect to the back plate in a second rotational direction.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 shows a deck light in accordance with an embodiment of the present invention wherein a front housing is separated from a back plate installed on a deck support post;

FIG. 2 is a front elevational view of the embodiment of FIG. 1 showing coupling of the front housing to the back plate installed on the deck support post;

FIGS. 3-5 are exploded views illustrating use of various styles of front housings to a common back plate in accordance with the present invention; and

FIG. 6 is a back elevational view of the back plate with a front housing coupled thereto.

Repeat use of reference characters in the present specification and drawings is intended to represent same or analogous features or elements of the invention.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations.

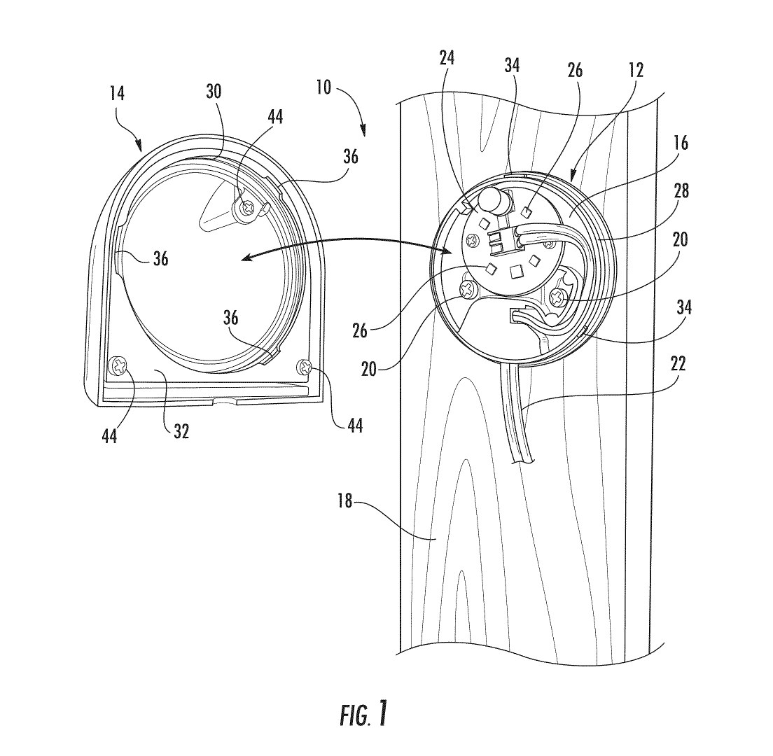

FIG. 1 shows a deck light fixture 10 in accordance with an embodiment of the present invention. As can be seen, fixture 10 generally includes a back plate 12 to which a front housing 14 can be coupled. Front housing 14 is interchangeable, meaning that it can have a variety of sizes, shapes, and functions as necessary or desired in a particular case. As a result, the homeowner can change the front housing over the years to provide a “new” light fixture while the infrastructure stays in place.

As can be seen, back plate 12 has a circular main portion 16 which is suitably attached to a fixed structure of the deck or the like. In this case, for example, main portion 16 is attached to a wooden support post 18 (e.g., a 4×4 support post) of a homeowner's deck such as using common wood screws 20. Electrical wiring 22 extends from main portion 16 for interconnection to the wiring system leading back to the transformer. In a preferred embodiment, the lighting fixture receives power in the same manner as prior art systems—i.e., by direct electrical wiring from the transformer or from another lighting fixture connected in parallel. In one example, the lighting fixture operates nominally at 12 VAC, but the input voltage may vary from 9 VAC to 15 VAC. One skilled in the art will appreciate, however, that various solar- or battery-powered systems are contemplated within the scope of the present invention.

Main portion 16 carries a suitable light source to provide the desired illumination. While a variety of light sources are contemplated, many preferred embodiments of the present invention utilize light emitting diode (LED) light sources for their longevity and energy efficiency. In this regard, main portion 16 includes a circuit board 24 having a plurality of LEDs, such as those indicated at 26. Circuit board 24 also carries other circuit components used to ensure proper operation of the LEDs.

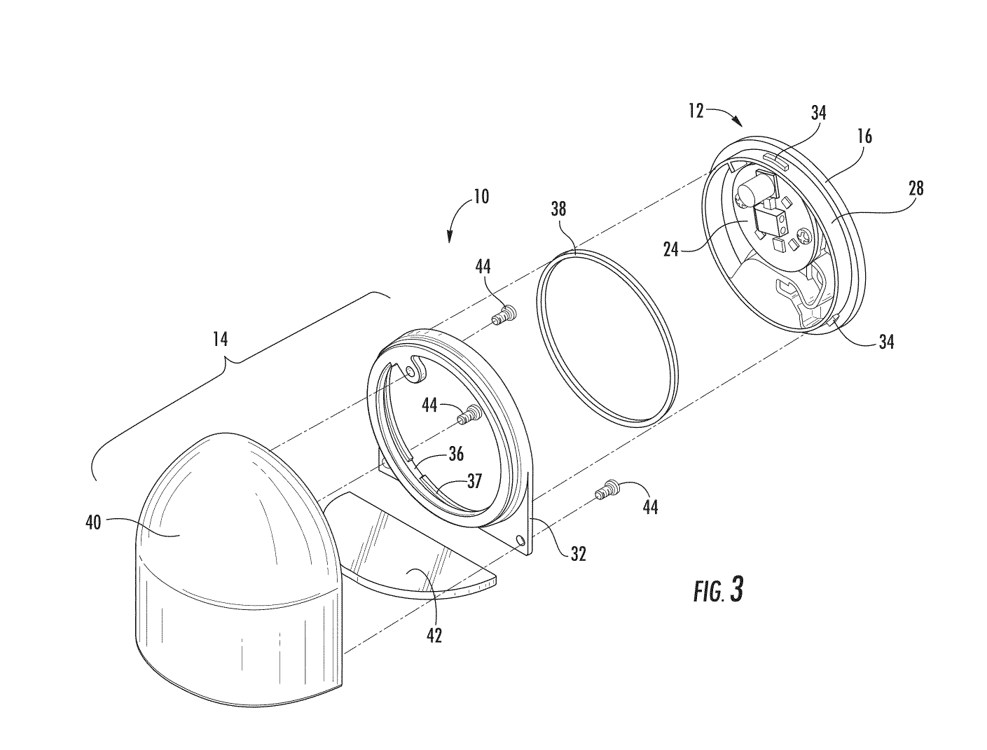

An annular flange 28 extends around the periphery of main portion 16, as shown. Flange 28 is configured to be received in a circular opening 30 defined in an adapter plate 32 of front housing 14. Flange 28 and circular opening 30 have a mating arrangement which allows front housing 14 to be removably coupled to back plate 12. In this case, for example, a plurality of (e.g., three) radial protrusions 34 are situated at spaced apart locations around flange 28. Radial protrusions 34 are sized to extend through corresponding slots 36 defined in circular opening 30. After the protrusions clear the slots, they will be received in an enlarged diameter groove 37 (FIG. 3) which allows rotation of front housing 14 with respect to back plate 12.

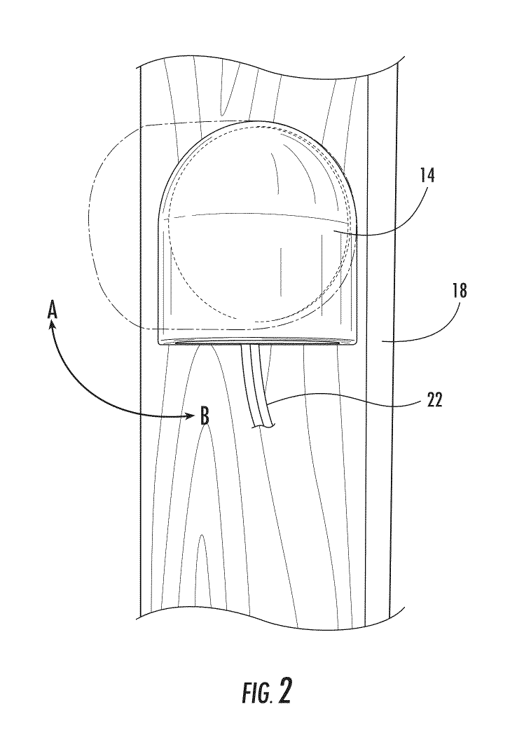

Thus, referring now also to FIG. 2, the manner in which front housing 14 is coupled to back plate 12 can be explained. Front housing 14 is moved to back plate 12 with front housing 14 in position A. In position A, protrusions 34 can be received through the slots 36. Once front housing 14 is fully seated on annular flange 28, it can be rotated to the final position for use (position B). Front housing 14 can be decoupled and removed by reversing this process.

Referring now to FIG. 3, certain additional details regarding fixture 10 can be seen. For example, a resilient O-ring 38 or other suitable seal may be placed at the interface of flange 28 and opening 30 in order to inhibit water penetration at this location. As can be seen, adapter plate 32 is generally configured to match the peripheral dimensions of a main cowling 40 of front housing 14. A transparent lens 42 is located, in this embodiment, in the downward-facing opening of main cowling 40 to allow light to escape in this direction. Specifically, lens 42 is captured and retained in this embodiment between main cowling 40 and adapter plate 32. Adapter plate 32 is suitably attached to main cowling 40 via any suitable means, such as screws 44. Screws 44 extend through apertures in adapter plate 32 and are received in threaded holes defined in main cowling 40.

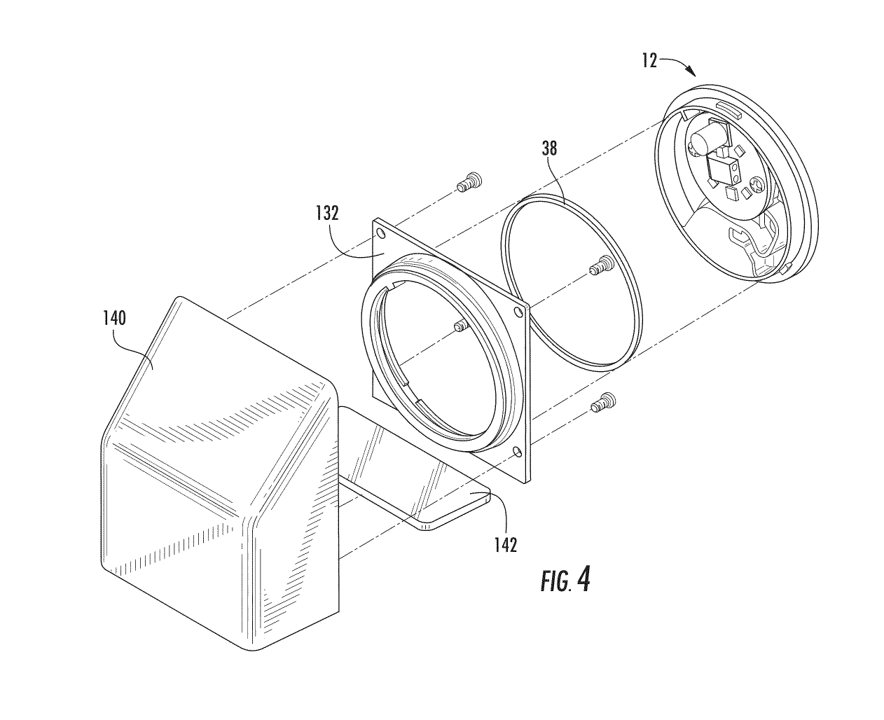

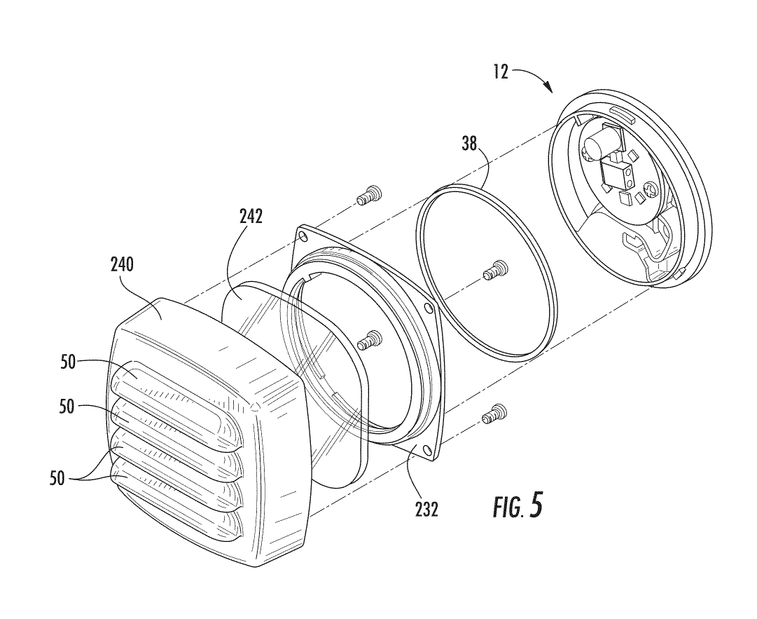

FIGS. 4 and 5 illustrate how back plate 14 can be used with a variety of different main cowlings. The adapter plate will be modified depending on the size and shape of the cowling with which it will be used. In FIG. 4, for example, the front housing includes an alternative main cowling 140 which is coupled with back plate 12 via a generally square adapter plate 132. A transparent lens 142 is located in a downward-facing opening of main cowling 140. FIG. 5 shows an alternative main cowling 240 which is coupled to back plate 12 via an adapter plate 232. In this case, light escapes through a series of horizontal openings defined by respective louvers 50 of main cowling 240. A transparent lens 242 is captured between adapter plate 232 and cowling 240.

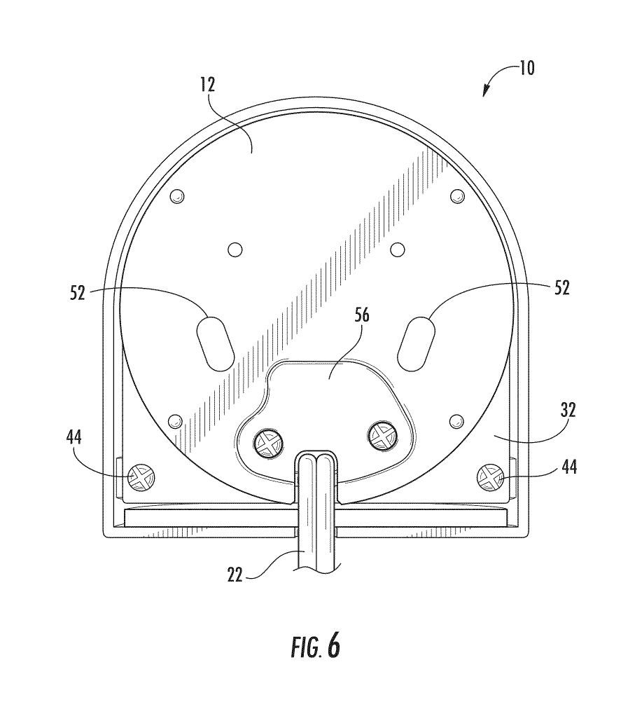

Certain additional details of light fixture 10 are shown in FIG. 6. As can be seen, back plate 12 defines one or more openings 52 through which suitable fasteners (e.g., wood screws 20) can be received for attachment to a support structure. A small removable access plate 56 facilitates passage of electrical wiring into back plate 12 during the assembly process.

It can thus be seen that the present invention provides a deck light having interchangeable front housings. Although the invention has been described using preferred embodiments any combination of the features discussed are included within the scope of the invention. Explanation is by way of example only and the disclosure is not meant to be limiting.

1. A deck light comprising:
a back plate having a light source, said back plate configured for attachment to a fixed support structure;
a front housing configured for removable coupling to said back plate, said front housing directing escape of light from said light source in a predetermined direction;
one of said back plate and said front housing having a circular opening and another of said back plate and said front housing having a circular flange receivable in said circular opening; and
an interconnect arrangement carried by said circular opening and said circular flange, said interconnect arrangement configured to removably couple said front housing to said back plate.

2. A deck light as set forth in claim 1, wherein said circular opening is defined in said front housing and said back plate includes said circular flange.

3. A deck light as set forth in claim 2, wherein interconnect arrangement comprises at least one radial protrusion on said circular flange and a corresponding slot defined in said circular opening through which said protrusion passes during coupling of said front housing to said back plate.

4. A deck light as set forth in claim 3, wherein said at least one radial protrusion comprises at least three radial protrusions which pass through corresponding of said slots.

5. A deck light as set forth in claim 3, wherein said front housing includes a main cowling to which an adapter plate is attached, said circular opening being defined in said adapter plate.

6. A deck light as set forth in claim 5, wherein said adapter plate is generally configured to match the peripheral dimensions of said main cowling.

7. A deck light as set forth in claim 5, wherein said front housing further comprises a lens.

8. A deck light as set forth in claim 1, wherein said front housing is coupled to said back plate by rotation of said front housing with respect to said back plate.

9. A deck light as set forth in claim 5, wherein said front housing is configured such that from said light source escapes in a downward direction.

10. A deck light as set forth in claim 5, wherein said main cowling defines a series of louvers defining respective openings for escape of light therethrough.

11. A deck light as set forth in claim 5, wherein said adapter plate is attached to said main cowling via a plurality of threaded fasteners.

12. A deck light as set forth in claim 1, comprising a plurality of said front housings that may be interchangeably coupled to said back plate.

13. A deck light as set forth in claim 1, wherein said light source comprises at least one LED.

14. A deck light comprising:
a back plate configured for attachment to a fixed support structure, said back plate carrying at least one LED;
electrical wiring extending to said back plate for connection to an external power source;
a front housing configured for removable coupling to said back plate, said front housing directing escape of light from said light source in a predetermined direction;
said front housing including a main cowling to which an adapter plate is attached, a circular opening being defined in said adapter plate;
said back plate having a circular flange receivable in said circular opening; and
an interconnect arrangement carried by said circular opening and said circular flange, said interconnect arrangement configured to removably couple said front housing to said back plate.

15. A deck light as set forth in claim 14, wherein said interconnect arrangement comprises at least one radial protrusion on said circular flange and a corresponding slot defined in said circular opening through which said protrusion passes during coupling of said front housing to said back plate.

16. A deck light as set forth in claim 15, wherein said at least one radial protrusion comprises at least three radial protrusions which pass through corresponding of said slots.

17. A deck light as set forth in claim 14, wherein said adapter plate is generally configured to match the peripheral dimensions of said main cowling.

18. A deck light as set forth in claim 14, wherein said front housing further comprises a lens.

19. A method of interchanging a first front housing of a deck light with a second front housing, said method comprising steps of:
providing a deck light having a back plate attached to a fixed support structure, said back plate carrying at least one LED as a light source;
said back plate having a circular flange with at least one interconnect feature configured to removably couple with a corresponding interconnect feature of said first front housing and said second front housing;
removing said first front housing at least in part by rotation of said first front housing with respect to said back plate in a first rotational direction; and
coupling said second front housing at least in part by rotation of said second front housing with respect to said back plate in a second rotational direction.
